(19) United States
(12) Patent Application Publication
(10) Pub. No.: US 2006/0054197 A1
(43) Pub. Date: Mar. 16, 2006

(54) Dishwasher

(75) Inventors: Sang Heon Yoon, Seoul (KR); Nung Seo Park, Bupyeong-gu (KR); Dae Yeong Han, Seoul (KR); Hung Myong Cho, Gimhae-si (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/056,403

(22) Filed: Feb. 14, 2005

(30) Foreign Application Priority Data
Sep. 14, 2004 (KR) P2004-73399

(51) Int. Cl. B08B 3/00

(52) U.S. Cl. 134/56 D; 134/58 D

(57) ABSTRACT

Dishwasher including a flow passage control valve for selective control of a flow direction of washing water, a motor coupled to the flow passage control valve for driving the flow passage control valve, a cam and a switch in contact with each other for controlling the motor, and a sump having a motor mounting part and a switch mounting part formed adjacent to each other, the motor mounting part being for mounting the motor and the cam, and the switch mounting part being for mounting the switch, thereby permitting easy and safe mounting of the valve control device by forming positioning parts and locking parts on an outside of an underside of the sump for mounting a microswitch, and to reduce cost of the valve control device by using mechanical microswitch.

### CROSS-REFERENCE TO RELATED APPLICATION

This application claims the benefit of Korean Application No. P2004-0073399 filed on Sep. 14, 2004, which is hereby incorporated by reference as if fully set forth herein.

### BACKGROUND OF THE INVENTION

1. Field of the Invention

The present invention relates to dishwashers, and more particularly, to a dishwasher which can control a flow of washing water conveniently, and effectively.

2. Discussion of the Related Art

In general, the dishwasher washes dishes automatically. Since the dishwasher washes, rinses, dries, and stores the dishes, the dishwasher can reduce domestic work.

In washing methods of the dishwasher, there is a shower type, and a ultrasonic type, of which shower type is used widely in home. In the shower type, warm water having detergent dissolved therein is sprayed to the dishes on racks for washing. The water is sprayed by a propeller, or nozzles in a rotating pipe.

A related art dishwasher will be described briefly, with reference to FIG. 1.

The related art dishwasher is provided with a water holding part 1, and upper, and lower washing parts 3, and 4, for spraying water introduced thereto from the water holding part, respectively.

The water holding part 1 has a main water collecting part 1a for receiving water from an outside of the dishwasher, and collecting and discharging contaminated water after washing the dishes. Over the main water collecting part 1a, there is a channel forming part 1b having flow passages formed therein for moving washing water circulating within the dishwasher to the upper, and lower washing parts. The channel forming part 1b has a filtering part 1c connected thereto for filtering contaminants from the washing water.

The motor 2 provides power for driving a washing pump for supplying the washing water to the upper and the lower washing parts 3, and 4 during dishwashing, or driving a discharge pump for discharging the washing water after finish of the washing.

The upper, and lower washing parts 3, and 4, places for washing the dishes actually, are connected to the water holding part with connection pipes. Spray arms (not shown) of the upper, and lower washing parts 3, and 4 spray the washing water supplied from the water holding part 1, to wash the dishes.

The steps of a process for operating the related art dishwasher will be described.

After placing dishes intended to wash in the rack, a cycle the user desires is entered. Then, the washing water is filled in the main water collection part of the dishwasher through a water supply valve connected to an outside of the dishwasher.

Then, the dishwasher puts a heater into operation, to heat the washing water, and puts the motor into operation, to drive the washing pump. Then, the heated washing water moves to the upper, and lower spray arms through the connection pipes by the washing pump. The washing water reached to the spray arms is sprayed through the spray nozzles, and removes contaminants from a surface of the dish.

The contaminants and the washing water removed from the dishes after the dishwashing are collected to the main collection part. If a level of contamination of the washing water is higher than a certain level, the dishwasher discharges the contaminated washing water through the discharge pump, and has fresh water received from an outside of the dishwasher.

However, if the level of the contamination is below the certain level, the dishwasher cleans the washing water collected at the main collection part, and supplies to the upper and lower spray arms by using the washing pump, again. The washing water collected at the main collection part after finish of washing is discharged to an outside of the dishwasher by the discharge pump, together with the contaminants.

In the meantime, the related art dishwasher is provided with a three-way valve for controlling a direction of the washing water, mostly a solenoid valve. The solenoid valves, opened/closed automatically by an electromagnetic principle, are widely used in automation of complicated machines, or safety devices.

However, the related art dishwasher has the following problems.

The related art dishwasher has a flow control device which controls a direction of the washing water, which is not only complicate, but also has a complicated mounting structure.

### SUMMARY OF THE INVENTION

Accordingly, the present invention is directed to a dishwasher that substantially obviates one or more problems due to limitations and disadvantages of the related art.

An object of the present invention is to provide a dishwasher, which has a simple and easy mounting structure of a valve control device which controls a flow direction of washing water.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a dishwasher includes a flow passage control valve for selective control of a flow direction of washing water, a motor coupled to the flow passage control valve for driving the flow passage control valve, a cam and a switch in contact with each other for controlling the motor, and a sump having a motor mounting part and a switch mounting part formed adjacent to each other, the motor mounting part being for mounting the motor and the cam, and the switch mounting part being for mounting the switch.

Preferably, the switch mounting part includes positioning parts for positioning the switch when the switch is mounted on an underside surface of the sump, and locking parts for holding the switch.

Preferably, the positioning parts are formed at least one place of the underside surface of the sump, opposite to each other in a diagonal direction.

Preferably, the positioning part includes a positioning guide projected from an underside surface of the sump, and a guide wall projected from the underside surface of the sump adjacent to the positioning guide.

Preferably, the positioning guide is in complementary to the positioning hole in the switch, and the guide wall is in complementary to an outside corner of the switch, and more preferably, the guide wall has a height higher than a height of the positioning guide.

Preferably, the locking part includes a body of the locking part, and a head part at an end of the body.

Preferably, the head part is stepped from the body, and the head part includes a sloped part having a predetermined slope angle formed at an upper surface of the head part.

Preferably, the locking part is formed at least one place of the underside surface of the sump, and projected higher than the upper surface of the switch, and more preferably, the locking part is formed of an elastic material.

Preferably, the sloped part has a predetermined slope angle from an upper part to a lower part such that the switch is inserted with sliding when the switch is mounted on the switch mounting part.

Preferably, the switch mounting part further includes a supplementary positioning rib for supplementing positioning of the switch.

Preferably, the switch includes a rib inserting groove in complementary to the supplementary positioning rib.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a block diagram of a related art dishwasher system;

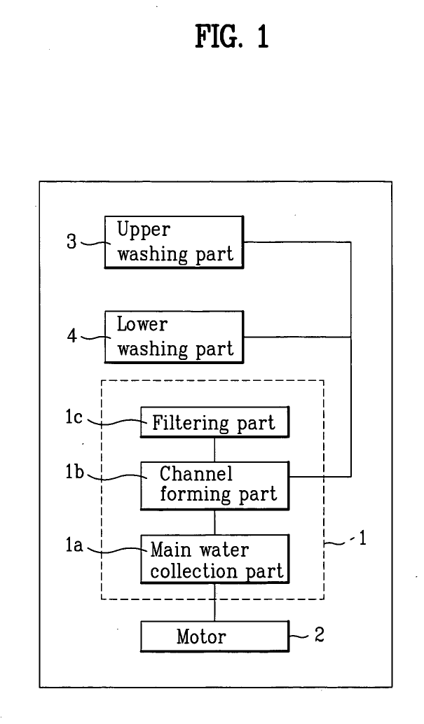

FIG. 2 illustrates a block diagram of a dishwasher system in accordance with a preferred embodiment of the present invention;

FIG. 3 illustrates an exploded perspective view of key parts in FIG. 2;

FIG. 4 illustrates an exploded perspective view of a flow passage control device in accordance with a preferred embodiment of the present invention; and

FIG. 5 illustrates a perspective view of a switch being mounted on an outside of the sump in accordance with a present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

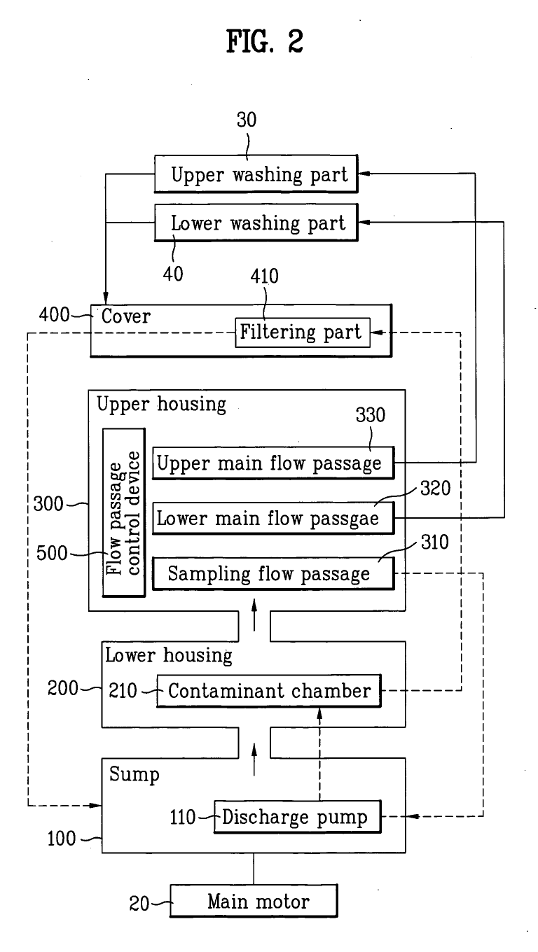

Flow paths of washing water in the dishwasher of the present invention will be described, with reference to FIG. 2.

At a lower portion of the dishwasher, there is a sump 100 for holding the washing water, and over the sump 100, there is a lower housing 200 having a contaminant chamber 210 formed therein. Over the lower housing 200, there is an upper housing 300 having flow passages of the washing water formed therein, and over the upper housing 300, there is a cover 400 for covering the upper housing.

The washing water is moved from the sump 100 to the upper housing 300 through the lower housing 200 by the washing pump. Then, by the flow passage control device 500, the washing water is moved to the upper washing arm through an upper main flow passage 330 in the upper housing 300, and to the lower washing arm through the lower main flow passage 320.

A portion of the washing water is moved to the discharge pump 110 through a sampling flow passage 310. The washing water passed through the discharge pump 110 is introduced into the contaminant chamber 210 in the lower housing 200, and filtered by a filtering part 410 in the cover 400. The washing water filtered at the filtering part 410 is collected to the sump 100, again.

Different from the related art dishwasher, the dishwasher of the present invention has the sampling flow passage 310 for measuring a level of contamination and filtering. Because the sampling flow passage 310 is connected to the contaminant chamber 210 through the washing pump and the discharge pump 110, a pressure on the filtering part 410 becomes lower by the washing pump. According to this, the filtering part 410 in the cover 400 is not liable to be blocked by the contaminants.

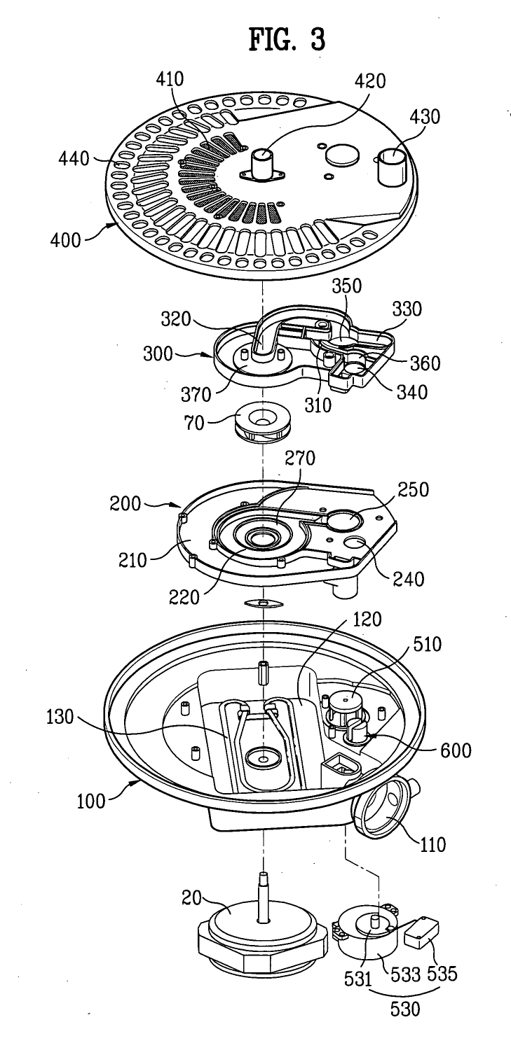

The water holding device of the dishwasher in FIG. 2 will be described in detail, with reference to FIG. 3.

Under the water holding device, there is a main motor 20 for providing power to the dishwasher, and over the main motor 20, there is a sump 100 having a washing water collection part 120 formed therein for collecting the washing water.

Over the sump 100, there is a lower housing having a contaminant chamber 210 formed therein, and, over the lower housing 200, there is an upper housing 300 having a flow passage for the washing water formed therein. Moreover, over the upper housing 300, there is a cover 400 for filtering, and returning the washing water to the sump 100, again.

There is a heater 130 in the sump 100. It is preferable that the heater 130 is always submerged in the washing water while the dishwasher is in operation. The heater 130 heats the washing water to an appropriate temperature, for easy washing of the dishes.

On an underside of the sump 100, there are the main motor 20, and a valve control device 530 for controlling a flow passage control valve, and a discharge pump 110 at one side of outside thereof. The main motor and the valve control device may be mounted on one side of outside of the sump, and the discharge pump may be mounted on the underside of outside of the sump.

Formed in the lower housing 200, there is a first pass through hole 240 for passing through of a contamination level measuring sensor 600 for measuring a contamination level of the washing water, and a contaminant chamber 210 for collecting the washing water from the contamination level measuring sensor 600 and the discharge pump 110.

At the center of the lower housing 200, there is an impeller holding part 270 for holding an impeller 70, and on an outside of the impeller holding part 270, there is an introduction flow passage 220 for introduction of the washing water to the flow passage control valve 510 by using the impeller. There is a second pass through hole 250 in a portion of the lower housing 200 the introduction flow passage 220 is connected thereto for passing through of the flow passage control valve 510.

The upper housing 300 has an impeller cap 370 for receiving an upper portion of the impeller 70, and a second pass through hole 350 for passing through of the flow passage control valve 510. The upper housing 300 also has an upper main flow passage 330 connected to the second pass through hole 350 for guiding the washing water to the upper washing arm, a lower main flow passage 320 for guiding the washing water to the lower washing arm, and a sampling flow passage 310 for guiding the washing water to the discharge pump 110.

In the sample flow passage, there is an enlarged flow passage part 360 having a first pass through hole 340 for passing through of the contamination level measuring sensor. Though it is preferable that the upper housing and the lower housing are separable type, they may be a unit type.

The impeller 70 between the upper housing 300 and the lower housing 200 is coupled to the main motor 20 with a shaft. The impeller 70 is rotated by the main motor 20, for introduction of the washing water from the washing water collection part 120 of the sump 100 to the introduction flow passage 220.

The washing water passed through the introduction flow passage 220 is divided into the upper main flow passage 330, the lower main flow passage 320, and the sampling flow passage 310.

The flow passage control device includes a flow passage control valve 510 for controlling a flow direction of the washing water, a valve control device 530 for controlling the flow passage control valve 510, and a packing member (not shown) between the flow passage control valve and the valve control device. The flow passage control valve 510 and the packing member are mounted on an inside of the sump, and the valve control device 530 is mounted on an underside of an outside of the sump.

The cover 400 has a filtering part 410 at a center for filtering, and recovery holes 440 of predetermined forms in a periphery for recovering the washing water filtered at the filtering part 410 to the sump 100, again.

The cover 400 has an upper arm connection part 430 for serving as a passage through which the washing water moves from the upper main flow passage to the upper spray arm, and a lower arm connection part 420 for serving as a passage through which the washing water moves from the lower main flow passage to the lower spray arm. The cover 400 may be joined to the upper housing 300 as one unit by thermofusion, or mounted individually and held together with fastening means.

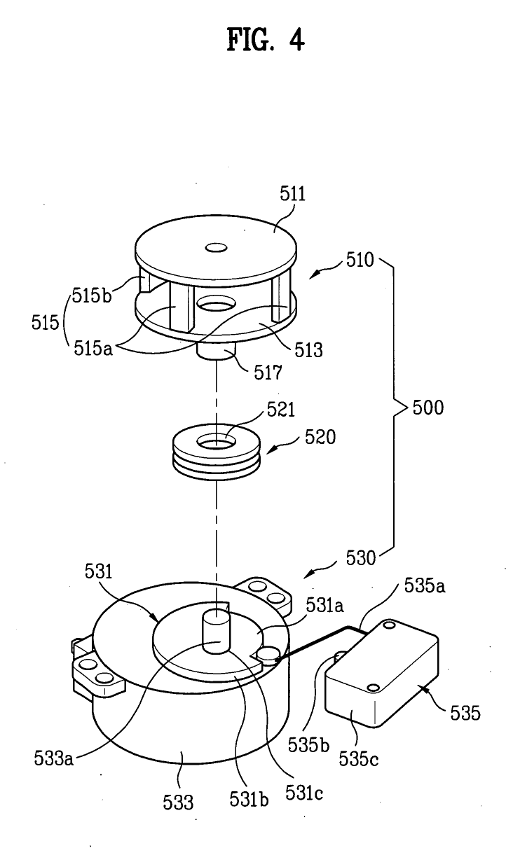

The structure of the flow passage control device in FIG. 3 will be described in detail, with reference to FIG. 4.

The flow passage control device 500 includes a flow passage control valve 510 for controlling a flow direction of the washing water, a valve control device 530 for controlling the flow passage control valve 510, and a packing member 520 between the flow passage control valve and the valve control device. The flow passage control valve 510 and the packing member 520 are mounted on an inside of the sump, and the valve control device 530 is mounted on an underside of an outside of the sump.

The flow passage control valve 510 includes an upper plate 511 forming an upper part of the valve, a lower plate 513 spaced from, and positioned under the upper plate, ribs 515 connected between the upper plate and the lower plate, and a valve coupling boss 517 for coupling to the valve control device.

The upper plate 511 and the lower plate 513 are opposite to each other, and have same sized disk shapes. The upper plate 511 and the lower plate 513 are connected with the ribs 515. The rib 515 has one main rib 515b and two subribs 515a.

The rib 515 may has at least one rib. It is preferable that the main rib 515b has a width greater than a width of the upper main flow passage of the upper housing, or a width of the lower main flow passage (not shown) of the upper housing, and the width of the subrib 515a has a width smaller than the width of the main rib.

There is a valve coupling boss 517 at a center for coupling to the valve control device 530. That is, the valve coupling boss 517 has the motor shaft 533a inserted therein. The valve coupling boss 517 has a length of cylindrical shape in communication with an inside space of the flow passage control valve 510. The shape is not limited to this, but any shape is viable as far as the shape can fit in the motor shaft 533a.

The valve control device 530 includes a motor 533 for driving the flow control valve 510, and a switch 535 and a cam for controlling the motor.

The motor 533 is preferably reversible, and a synchronous motor which rotates at a constant speed at a frequency regardless of load.

The cam 531 is mounted on the motor 533 such that a rotating shaft of the cam and the rotating shaft of the motor are positioned in the same axis. The cam has a shaft pass through hole 531c in complementary to the motor shaft.

As the motor shaft 533a is joined to the shaft pass through hole 531c, the cam 531 is rotatable with the motor shaft 533a. Though the motor shaft and the cam may be joined by forced fit, they may be joined by screw fastening.

The cam 531 includes a first circumferential surface 531a having a small radius, and a second circumferential surface having a great radius. The first circumferential surface 531a and the second circumferential surface 531b are stepped to each other, and it is preferable that a central angle of the second circumferential surface is greater than a central angle of the first circumferential surface.

The switch 535 includes a body 535c, a lever 535a extended from one side of the body, and a projection 535b for being brought into contact with/brought away from the contact with, the lever 535a.

The body 535c forms a body of the switch, and the lever at one side of the body 535c is in contact with a circumferential surface of the cam 531. The projection 535b at one side of the body 535c is brought into contact with the lever 535a depending on a moving direction of the cam 531.

That is, the switch 535 is brought into contact with/brought away from the contact with the cam, to turn on/off the motor. It is preferable that the switch 535 is a microswitch.

The packing member 520 is mounted between the flow passage control valve 510 and the valve control device 530, and seals the valve control device 530 for preventing infiltration of water therein.

The packing member 520 has pleats at a contact surface with the flow passage control valve 510, for making close contact with the flow passage control valve. The packing member 520 has a coupling boss pass through hole 521 for passing through of the valve coupling boss 517. It is preferable that the packing member is formed of an elastic material, and, more preferably of a synthetic rubber.

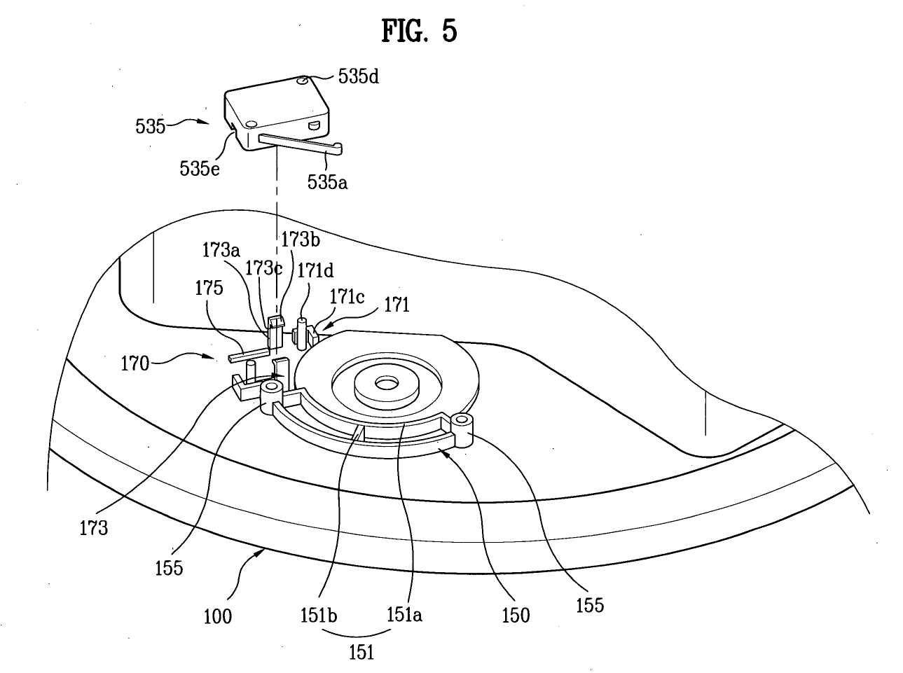

A structure in which the valve control device is mounted on an outside of the sump of the dishwasher will be described, with reference to FIG. 5.

Formed on an outside of the sump 100, there are a motor mounting part 150 for securing the motor of the flow passage control valve thereto, and a switch mounting part 170 for securing the switch of the motor thereto. It is preferable that the switch and the motor are mounted adjacent to each other, for positioning the lever 535a of the switch within a range of contact with the cam (not shown) on the motor.

The motor mounting part 150 has a shape of a section of a ring with predetermined center angle and thickness. The motor mounting part 150 includes reinforcing ribs 151 for increasing strength of an outside of the sump, and motor fastening bosses 155 for securing the motor to the sump.

The reinforcing ribs 151 form a rim of the motor mounting part, and have rim supporting walls 151a projected to an outside of the sump with a predetermined width, and a middle supporting wall 151b connected between the rim supporting walls 151a. It is preferable that there is at least one middle supporting wall 151b.

The motor fastening bosses 155 are at predetermined positions of the reinforcing ribs 151, and have female thread parts, respectively. It is preferable that the motor fastening bosses are projected longer than the reinforcing ribs. Moreover, it is preferable that there is at least one motor fastening boss 155.

The switch mounting part 170 includes positioning parts 171 for positioning the switch at the time of mounting, and locking parts 173 for locking the switch after mounting the switch.

It is preferable that the switch mounting part 170 has a supplementary positioning part 175 for supplementing positioning of the switch at the time of mounting the switch. The switch mounting part may have a separate fastening part for securing the switch to the sump, i.e., fastening means of screws, or bolts/nuts.

The switch positioning parts 171 each includes a positioning guide 171d in complementary to a positioning hole 535d in the switch, and a guide wall 171c in complementary to an outside corner of the switch 535. It is preferable that the positioning parts 171 are opposite to each other in a diagonal direction, and formed at least one place.

As the positioning guides 171d are inserted in the positioning holes 535d in the switch respectively, the switch 535 is mounted on the switch mounting part 170, easily. The positioning guides 171d also support the switch after the switch is mounted.

Though it is preferable that the positioning guide is cylindrical, a shape of the positioning guide is not limited this, but all polygon, starting from rectangle, are viable.

The guide wall 171c is at a position spaced a predetermined distance from the positioning guide 171d, and projected from the sump to an outside thereof. The guide wall 171c not only positions the switch at the time of mounting the switch, but also supports the switch 535.

The guide wall 171c is projected in a shape in complementary to the corner of the switch. That is, the corner of the switch is brought into contact with an inside wall of the guide wall. It is preferable that the guide wall 171c is projected lower than the positioning guide 171. The guide wall may have a height the same or higher than the positioning guide.

The switch locking parts 173 prevent the switch 535 from falling off, and each includes a body 173a for being brought into contact with a side of the switch, and a head part at an end of the body.

The head part includes a sloped part 173b having a predetermined slope angle, and a holding part 173c at an end of the sloped part. It is preferable that the locking part 173 is provided at least one place of the switch mounting part.

The body part 173a has a rectangular column projected from an outside surface of the sump, and is brought into contact with one side surface of the switch 535. The sloped part 173b is at a top of the body, and has a slope angle from an outside to an inside of a space the switch 535 is to be mounted therein. The slope angle is provided for slidably inserting the switch.

The holding part 173c is a stepped part between the body part 173a and the sloped part 173b. The holding part 173c prevents the switch 535 from falling off after the switch is mounted, to secure the switch to the under side of the sump.

It is preferable that the locking part 173 is formed of an elastic material, such as plastic having a certain strength. That is, the switch 535 is mounted easily owing to the elasticity, and is supported owing to the restoring force of the elasticity.

The supplementary positioning rib 175 has a shape of a projection in complementary to a rib inserting groove 535e in one side of the switch. The supplementary positioning rib 175 supplements positioning of the switch at the time of mounting the switch, and supports the switch after the switch is mounted.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

As has been described, the dishwasher of the present invention has the following advantages.

First, the positioning part on an outside of an underside of the sump for mounting a microswitch permits an easy mounting of the valve control device.

Second, the locking part on an outside of underside of the sump for mounting a microswitch permits safe mounting of the valve control device.

Third, the use of the microswitch for a mechanical valve control device permits to drop a cost of the valve control device.

What is claimed is:

1. A dishwasher comprising:
a flow passage control valve for selective control of a flow direction of washing water;
a motor coupled to the flow passage control valve for driving the flow passage control valve;
a cam and a switch in contact with each other for controlling the motor; and
a sump having a motor mounting part and a switch mounting part formed adjacent to each other, the motor mounting part being for mounting the motor and the cam, and the switch mounting part being for mounting the switch.

2. The dishwasher as claimed in claim 1, wherein the switch mounting part includes positioning parts for positioning the switch when the switch is mounted on an underside surface of the sump, and locking parts for holding the switch.

3. The dishwasher as claimed in claim 2, wherein the positioning parts are formed at least one place of the underside surface of the sump, opposite to each other in a diagonal direction.

4. The dishwasher as claimed in claim 3, wherein the positioning part includes;
a positioning guide projected from an underside surface of the sump, and
a guide wall projected from the underside surface of the sump adjacent to the positioning guide.

5. The dishwasher as claimed in claim 4, wherein the positioning guide is in complementary to the positioning hole in the switch, and the guide wall is in complementary to an outside corner of the switch.

6. The dishwasher as claimed in claim 4, wherein the guide wall has a height higher than a height of the positioning guide.

7. The dishwasher as claimed in claim 2, wherein the locking part includes;
a body of the locking part, and
a head part at an end of the body.

8. The dishwasher as claimed in claim 7, wherein the head part is stepped from the body, and the head part includes a sloped part having a predetermined slope angle formed at an upper surface of the head part.

9. The dishwasher as claimed in claim 7, wherein the locking part is formed at least one place of the underside surface of the sump, and projected higher than the upper surface of the switch.

10. The dishwasher as claimed in claim 8, wherein the locking part is formed of an elastic material.

11. The dishwasher as claimed in claim 8, wherein the sloped part has a predetermined slope angle from an upper part to a lower part such that the switch is inserted with sliding when the switch is mounted on the switch mounting part.

12. The dishwasher as claimed in claim 2, wherein the switch mounting part further includes a supplementary positioning rib for supplementing positioning of the switch.

13. The dishwasher as claimed in claim 12, wherein the switch includes a rib inserting groove in complementary to the supplementary positioning rib.
